(19) United States
(12) Patent Application Publication
(10) Pub. No.: US 2018/0320656 A1
(43) Pub. Date: Nov. 8, 2018

(54) Wind Funneling Device for Energy Production

(71) Applicant: Herbert Newsam, Willamina, OR (US)

(72) Inventor: Herbert Newsam, Willamina, OR (US)

(21) Appl. No.: 15/586,384

(22) Filed: May 4, 2017

(51) Int. Cl. F03D 3/04; F03D 9/00; F03D 9/25; F03D 5/00; H02K 7/18; H02J 7/35; H02S 10/12; F03G 7/08

(52) U.S. Cl. CPC F03D 3/0472; F03D 9/007; F03D 9/25; F03D 5/00; H02K 7/183; F05B 2220/709; H02S 10/12; F03G 7/08; F05B 2220/706; F05B 2240/13; F05B 2220/708; H02J 7/35

(57) ABSTRACT

A wind funneling device for energy production. The present system includes a wind funneling device for energy production having a housing with side panels, a top panel and a rear panel forming an interior volume with a front opening and a lower opening. A plurality of parallel planar members is disposed within the interior volume of the housing, wherein each of the plurality of parallel planar members extends parallel to the side panels. One or more wind vanes are secured to the housing and configured to direct the front opening to the direction of the wind. An electric generator is connected to the housing. Air flows toward the generator, producing electricity. A battery is operably connected to the generator to store the electricity for future use. Solar panels and a vibration powered generator may provide an additional source of energy production.

### BACKGROUND OF THE INVENTION

The present invention relates to devices designed to assist in the efficient production of clean energy. Energy is among the most valuable resources in the modern world, and production of clean energy is of prime importance. It is crucial to maximize environmentally safe and efficient methods of energy production.

Among the current methods used for energy production are wind turbines, as wind is abundant and freely available. However, generating substantial electricity from wind can be difficult and inefficient. Many of the wind turbines currently available on the market are fixed in place and non-movable. This construction limits the effectiveness of maximizing electricity that can be produced from the mechanical energy of the wind, as wind directions change frequently and optimizing energy production requires placing a generator at an ideal angle relative to the wind. While some turbines do incorporate rotating mechanisms, many of the generators incorporated within the turbine are heavy, and thus require the expenditure of significant power to rotate the turbine.

Furthermore, these devices are designed to provide electricity from a single source, wind. Because there are times when the wind ceases to blow, there is no electricity generated during these periods. Accordingly, a device designed to harness wind efficiently as well as provide additional means of energy production is desired.

### SUMMARY OF THE INVENTION

In view of the foregoing disadvantages inherent in the known types of energy production devices now present in the prior art, the present invention provides a wind funneling device for energy production wherein the same can be utilized for providing convenience for the user when wishing to harness the energy of wind with increased efficiency.

The present system comprises a wind funneling device for energy production having a housing with two parallel side panels, a top panel and a rear panel forming an interior volume with a front opening and a lower opening. A funnel is disposed adjacent to the lower opening, the funnel having an open upper end abutting the lower opening, and an open lower end having an aperture that is narrower than the open upper end. In some embodiments of the wind funneling device for energy production, the rear panel is slanted at acute angle relative to a vertical axis.

A plurality of parallel planar members are disposed within the interior volume of the housing, extending from the top panel to the funnel, wherein each of the plurality of parallel planar members extends parallel to the side panels. Thus, the plurality of planar members assist in directing any airflow entering the interior volume of the housing via the front opening toward the funnel. One or more wind vanes are secured to the housing and extending from the top panel. In some embodiments, additional directional wind vanes are secured to the side panels of the housing.

An electric generator may be placed within a case in fluid communication with the funnel via a duct. As the air flows into the case, blades of the generator turn, producing electricity. A battery is operably connected to the generated to store the electricity for future use.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the wind funneling device for energy production.

FIG. 2 shows a front view of the wind funneling device for energy production.

FIG. 3 shows a rear view of the wind funneling device for energy production.

### DETAILED DESCRIPTION OF THE INVENTION

Reference is made herein to the attached drawings. Like reference numerals are used throughout the drawings to depict like or similar elements of the wind funneling device for energy production. The figures are intended for representative purposes only and should not be considered to be limiting in any respect.

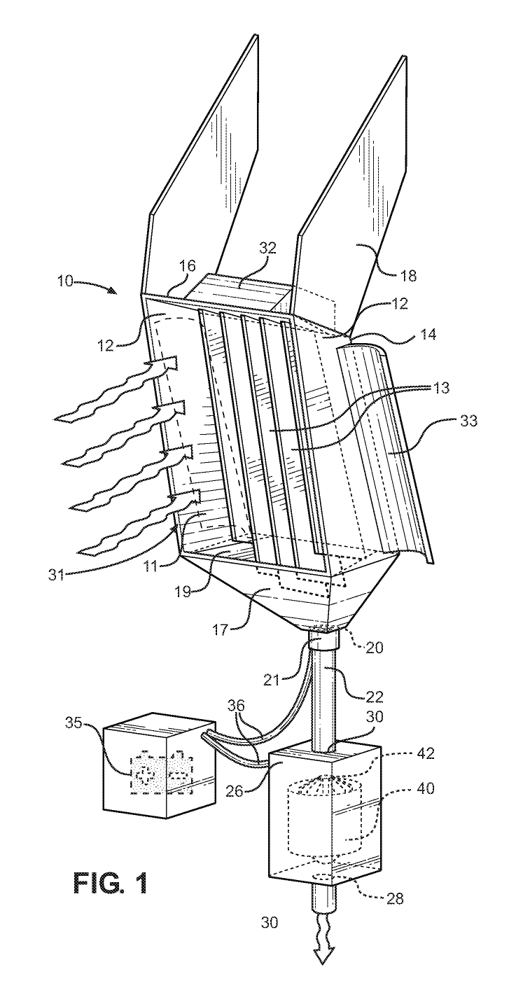

Referring now to FIG. 1, there is shown a perspective view of one embodiment of the wind funneling device for energy production. The wind funneling device for energy production 10 comprises a housing 31 forming an interior volume 11, the housing 31 further comprising two parallel side panels 12, a rear panel 14 extending therebetween, a top panel 16 enclosing the interior volume 11, and a front opening 31 and a lower opening 19. A funnel 17 is disposed adjacent to the lower opening 19, the funnel 17 having an open upper end and an open lower end having an aperture 20 that is narrower than the open upper end. In some embodiments of the wind funneling device for energy production 10, the rear panel 14 is positioned perpendicular to the side panels 12 and slanted at an acute angle relative to a vertical axis.

A plurality of parallel planar members 13 are disposed within the interior volume 11 of the housing, extending from the top panel 16 to the funnel 17, wherein each of the plurality of parallel planar members 13 extends parallel to the side panels 12. Thus, the plurality of planar members 13 assist in directing any airflow entering the interior volume 11 of the housing via the front opening 31 13 toward the funnel 17.

One or more wind vanes 18 are secured to the housing and extend from the top panel 16. In some embodiments, additional directional wind vanes 33 are secured to the side panels 12 of the housing. These vanes 33 may be curved in a concave shape facing the front of the housing 31 order to catch wind more efficiently than a planar vane.

A hinge is secured to a bottom end of the housing. In some embodiments, the hinge comprises a rotatable collar 21 disposed between the aperture 20 of the funnel 17 and a duct 22 that extends from the collar 21 toward a hollow case 26. The hollow case 26 comprises a housing having an inlet port 30 and an outlet port 28 for air to flow therethrough. The hinge is configured to allow the housing to pivot around a vertical axis. A generator 40 may be placed within the hollow case 26 and configured to generate electricity when fan blades 42 within the generator 40 are rotated via the airflow guided into the case 26 from the housing through the inlet port 30. In further embodiments, a battery 35 is operably connected to the generator 40 and is configured to store the generated electricity produced for future use.

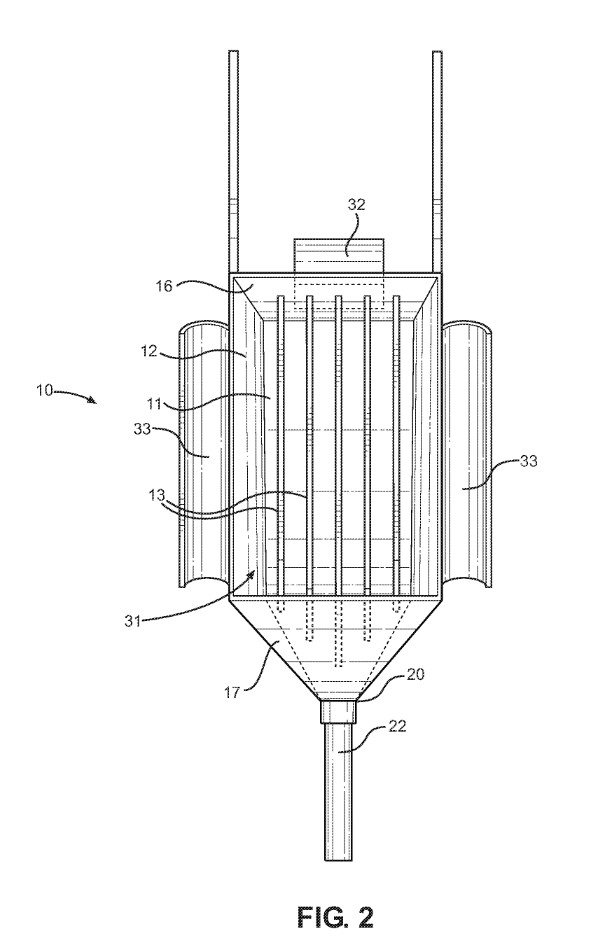

Referring now to FIG. 2, there is shown a front view of the wind funneling device for energy production. As the air flow enters the front opening of the housing 31, the plurality of planar members 13 guide the air toward the funnel 17. The parallel arrangement of the planar members 13 create a laminar air flow, increasing the efficiency of the electricity generation by minimizing any turbulence that would detract from constant and consistent air pressure.

In operation, the wind funneling device for energy production 10 is configured to have the front opening 31 face the direction of the wind. The wind vanes 18 are adapted to guide the housing and rotate it to ensure that the front opening 31 maintains that positioning relative to moving wind patterns. The additional curved vanes 33 that are secured to the side panels 12 of the housing assist in pivoting the wind funneling device 10 around a vertical axis via the hinge.

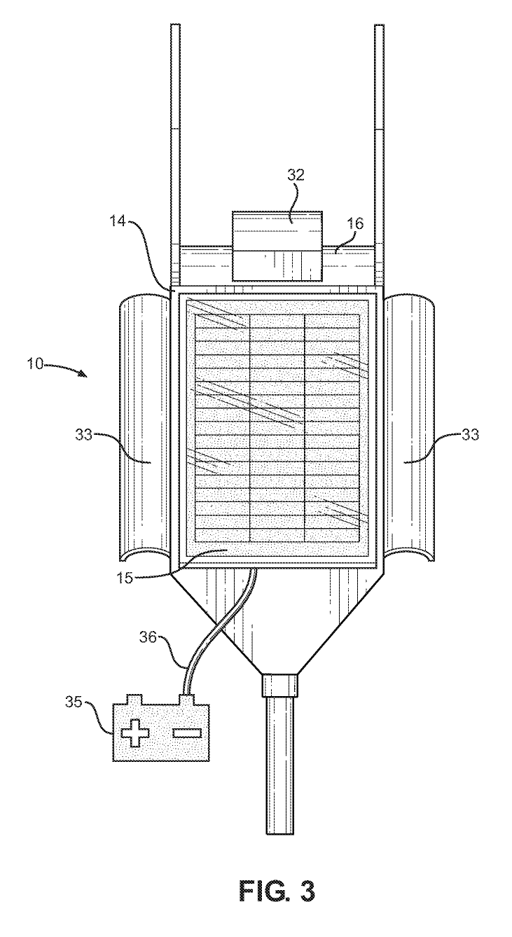

Referring now to FIG. 3, there is shown a rear view of the wind funneling device for energy production. In some embodiments of the wind funneling device for energy production 10, a solar panel 15 is secured to the housing. In the depicted embodiment, the solar panel 15 is secured to a rear surface of the rear panel 14. In another embodiment, the wind vanes 33 are adapted to support solar panels of varying dimensions. The solar panel 15 is operably connected to the battery 35 and is configured to generate electricity via photovoltaic cells. The electricity is then stored in the battery 35 for future use.

In some embodiments of the wind funneling device for energy production 10, a vibration powered generator 32 is secured to the housing. In the depicted embodiment, the vibration powered generator 32 is mounted onto the top panel 16 of the housing. The vibrations caused by wind and other environmental factor are transformed into electricity via the vibration powered generator 32, which is operably connected to the battery 35. Thus, the wind funneling device for energy production 10 allows for energy production and storage from wind energy as well as from solar energy and vibrational energy.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wind funneling device for energy production, comprising:
a housing forming an interior volume, the housing comprising two parallel side panels, a rear panel extending therebetween, a top panel and a front opening, the housing further comprising a funnel disposed on a bottom end thereof, the funnel having an open upper end and an open lower end having an aperture that is narrower than the open upper end;
a plurality of parallel planar members disposed within the interior volume of the housing, extending from the top panel to the funnel, wherein each of the plurality of parallel planar members extends parallel to the side panels;
a hinge secured to a bottom end of the housing, configured to allow the housing to pivot around a vertical axis;
one or more wind vanes extending from the top panel and positioned parallel to the side panels.

2) The wind funneling device for energy production of claim 1, wherein the wind vanes extend outwardly from the top panel and are angled toward the rear panel.

3) The wind funneling device for energy production of claim 1, wherein the rear panel is positioned perpendicular to the side panels

4) The wind funneling device for energy production of claim 1, further comprising a duct having a first end and a second end, wherein the first end is operably connected to the aperture of the housing.

5) The wind funneling device for energy production of claim 4, further comprising a case having an inlet port and outlet port, wherein the inlet port is connected to the second end of the duct.

6) The wind funneling device for energy production of claim 5, further comprising a wind generator disposed within the case.

7) The wind funneling device for energy production of claim 6, further comprising a battery operably connected to the wind generator.

8) The wind funneling device for energy production of claim 1, further comprising solar panels.

9) The wind funneling device for energy production of claim 8, wherein the solar panels are disposed on the rear panel.

10) The wind funneling device for energy production of claim 7, further comprising solar panels operably connected to the battery.

11) The wind funneling device for energy production of claim 1, further comprising a pair of curved directional vanes mounted along a length of the side panels.

12) The wind funneling device for energy production of claim 1, further comprising a vibration powered generator secured to the housing.

13) The wind funneling device for energy production of claim 7, further comprising a vibration powered generator operably connected to the battery.
